(19) United States
(12) Patent Application Publication
(10) Pub. No.: US 2005/0025906 A1
(43) Pub. Date: Feb. 3, 2005

(54) Method for improving film uniformity in plasma enhanced chemical vapor deposition system

(76) Inventors: Hui-Chu Lin Lin, Hsinchu (TW); Wen-Cheng Lu, Taipei (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/631,134

(22) Filed: Jul. 31, 2003

(51) Int. Cl. H05H 1/24

(52) U.S. Cl. 427/569

(57) ABSTRACT

A method for improving uniformity of a film in a plasma enhanced chemical vapor deposition system in a deposition chamber includes the following steps before a deposition procedure. Firstly, a cleaning procedure is performed to remove particles adhered onto an internal wall of the deposition chamber. Then, a pre-deposition procedure is performed to isolate contaminants generated during the clearing procedure. Afterward, a specified gas is introduced into the deposition chamber so as to stabilize a condition inside the deposition chamber.

### FIELD OF THE INVENTION

The present invention relates to a method for improving uniformity of a film, and more particularly to a method for improving uniformity of a film in a plasma enhanced chemical vapor deposition system.

### BACKGROUND OF THE INVENTION

A plasma enhanced chemical vapor deposition (PECVD) system is widely used to form a thin film on a substrate. The PECVD system is operated by using auxiliary energy provided by plasma to deposit the thin film so as to lower deposition temperature. Since light is emitted due to the action of plasma, the PECVD system is also referred to as a glow discharge system.

FIG. 1 is a schematic diagram illustrating a conventional PECVD system. The deposition chamber 10 of the PECVD system comprises an upper and a lower aluminum electrodes 12 and 14. The substrate or chip 16 to be deposited is placed on the lower electrode 14. The electrodes 12 and 14 are heated via resistor filaments or bulbs (not shown) to a temperature in a range from 100° C. to 400 ° C. When a radio frequency (RF) voltage of 13.56 MHz is applied between these two electrodes 12 and 14, a glow discharging effect occurs in a region 18 between these two electrodes 12 and 14. When a reaction gas is introduced into the deposition chamber 10, the reaction gas flows radially through the glow discharging region 18. The non-deposited material present in the deposition chamber after the reaction will be vented by a vacuum pump (not shown).

The reactive substances of the plasma used in the PECVD system are principally highly active ions or free radicals. Furthermore, the surface of the substrate 16 is activated when being collided by ions. Both factors contribute to the increase in the chemical reaction rate in the deposition chamber 10. Thus, one of the advantages of the PECVD system is that it can be operated at a relatively low temperature.

During the fabrication of an integrated circuit, the PECVD system is usually employed for depositing dielectric films such as SiO₂ or Si₃N₄. After a plurality of deposition cycles, some tiny particles of SiO₂ or Si₃N₄ may be adhered onto the internal wall of the deposition chamber 10. In order to eliminate the contamination of these adhered particles, a cleaning procedure is required by introducing a cleaning gas, for example nitrogen fluoride (NF₃), into the deposition chamber 10, and conducting a plasma auxiliary chemical reaction, thereby removing most of the adhered particles. Although the particle adherent on the internal wall of the deposition chamber 10 is largely removed by the cleaning procedure, certain contaminant such as fluoride, which is derived from the reacted cleaning gas, is likely to remain in the deposition chamber 10, for example on the internal wall.

Since the residual contaminants may lead to failure in the subsequent deposition process, a pre-deposition procedure is preferably performed in advance. The pre-deposition procedure is carried out by introducing the reaction gas to perform a deposition procedure on no substrate in the deposition chamber 10. Thus, the contaminants generated during the cleaning procedure are confined between the internal wall of the deposition chamber 10 and the pre-deposited material so as to be isolated from the subsequently deposited thin film. After the pre-depositing procedure is finished, the adverse effect caused by the presence of contaminants to the subsequent deposition procedure will be significantly reduced.

Although the pre-deposition procedure facilitates reducing the influence of the contamination resulting from the cleaning procedure, there still exist other problems. For example, the thin film deposited on the first substrate may have poor uniformity due to the unstable condition inside the deposition chamber. The poor uniformity leads to difficulty in process control and increasing cost. Therefore, there is a need for an improved PECVD process, whereby the conditions inside the deposition chamber are stabilized in order to achieve better uniformity.

### SUMMARY OF THE INVENTION

It is an object of the present invention to provide a method for improving uniformity of a film in a plasma enhanced chemical vapor deposition system by stabilizing the chamber condition.

In accordance with a first aspect of the present invention, there is provided a method for improving uniformity of a film in a plasma enhanced chemical vapor deposition system. Before a deposition procedure, the following steps are carried out. Firstly, a deposition chamber is provided. Then, a cleaning procedure is performed to remove particles adhered onto an internal wall of the deposition chamber. Then, a pre-deposition procedure is performed to isolate contaminants generated during the clearing procedure. Afterward, a specified gas is introduced into the deposition chamber so as to stabilize the condition inside the deposition chamber.

For example, the contaminants may include fluoride.

Preferably, the specified gas comprises at least a nitrogen gas, an argon gas or a hydrogen gas.

In one embodiment, the conditions to be stabilized are the temperature distribution and/or contaminant concentration conditions in the deposition chamber.

In one embodiment, the cleaning procedure is performed by introducing a nitrogen fluoride gas into the deposition chamber.

In one embodiment, the pre-deposition procedure is performed by introducing a reaction gas without placing any substrate into the deposition chamber.

In one embodiment, the method further comprises a step of idling the deposition chamber for a specified period of time for stabilizing temperature distribution in the deposition chamber.

In accordance with a third aspect of the present invention, there is provided a method for improving uniformity of a film in a plasma enhanced chemical vapor deposition system. Before a deposition procedure, the following steps are carried out. Firstly, a deposition chamber is provided. Then, a cleaning procedure is performed to remove particles adhered onto an internal wall of the deposition chamber. Then, a pre-deposition procedure is performed to isolate contaminants generated during the clearing procedure. Afterward, the deposition chamber is idled for a specified period of time so as to stabilize a condition inside the deposition chamber.

In one embodiment, the condition to be stabilized is the temperature distribution condition of the deposition chamber.

In one embodiment, the method further comprises a step of introducing a specified gas into the deposition chamber so as to dilute the contaminants inside the deposition chamber.

Preferably, the specified period of time is ranged from 1 minute to 20 minutes.

In accordance with a third aspect of the present invention, there is provided a method for improving uniformity of a film in a plasma enhanced chemical vapor deposition system. Before a deposition procedure, the following steps are carried out. Firstly, a deposition chamber is provided. Then, a cleaning procedure is performed to remove particles adhered onto an internal wall of the deposition chamber. Then, a pre-deposition procedure is performed to isolate contaminants generated during the clearing procedure. Afterward, the contaminants in the deposition chamber is diluted so as to stabilize a condition inside the deposition chamber.

In one embodiment, the contaminants are diluted with an introduced gas.

In one embodiment, the introduced gas includes at least a gas selected from a group consisting of nitrogen, argon, hydrogen and a combination thereof.

In one embodiment, the method further comprises a step of idling the deposition chamber for a specified period of time for stabilizing a temperature distribution of the deposition chamber.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating a conventional PECVD system;

FIG. 2 is a flowchart illustrating a method for improving uniformity of a film in a PECVD system according to a first preferred embodiment of the present invention;

FIG. 3 is a flowchart illustrating a method for improving uniformity of a film in a PECVD system according to a second preferred embodiment of the present invention; and

FIG. 4 is a flowchart illustrating a method for improving uniformity of a film in a PECVD system according to a third preferred embodiment of the present invention.

### DETAILED DESCRIPTION OF THE PREFERRED EMBODIMENT

As previously described, after a pre-deposition procedure, the thin film deposited on the first substrate in a PECVD system may have poor uniformity. In other words, the contaminants generated during the cleaning procedure are not fully isolated from the subsequently deposited thin film. The uniformity could be improved by providing a stable condition inside the deposition chamber.

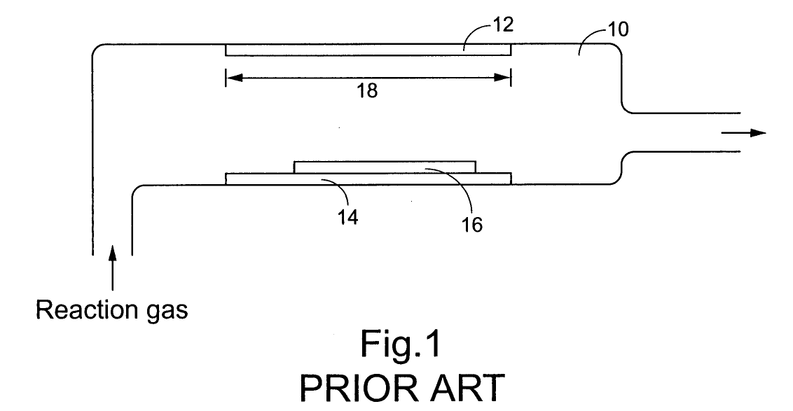

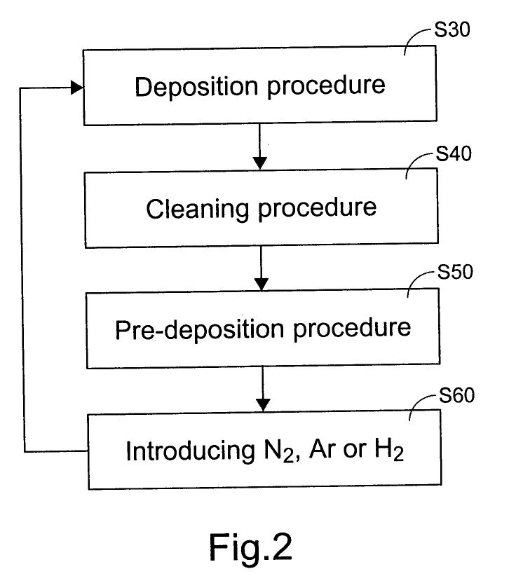

Therefore, the present invention provides a method for improving uniformity of a film in a PECVD system by stabilizing conditions inside the deposition chamber. The method will be illustrated with reference to the flowchart in FIGS. 2, 3 or 4. Since the apparatus of FIG. 1 is used for performing the present method, it is not necessary to be further described in detail herein.

FIG. 2 illustrates a method for improving uniformity of a film in a PECVD system according to a first preferred embodiment of the preset invention. In Step S30, some tiny particles of SiO₂ or Si₃N₄ are adhered onto the internal wall of the deposition chamber 10 after a plurality of deposition cycles. Then, in Step S40, a cleaning procedure is carried out by introducing a cleaning gas, for example nitrogen fluoride (NF), into the deposition chamber 10, and conducting a plasma auxiliary chemical reaction, thereby removing most of the adhered particles. After the cleaning procedure is carried out, certain contaminant such as fluoride, which is derived from the reacted cleaning gas, is likely to remain on the internal wall of the deposition chamber 10. Then, in Step S50, a pre-deposition procedure is performed by introducing the reaction gas without placing any substrate into the deposition chamber. Thus, the contaminants generated during the cleaning procedure are confined between the internal wall of the deposition chamber 10 and the pre-deposited material so as to be isolated from the subsequently deposited thin film. Then, in Step S60, a specified gas is introduced into the deposition chamber 10 so as to stabilize the condition, such as temperature distribution and/or contaminant concentration, in the deposition chamber 10. For example, it is desirable to unify the temperature distribution and/or lower the contaminant concentration inside the chamber. The specified gas preferably includes a nitrogen gas, an argon gas, a hydrogen gas or a combination thereof, or any other suitable gas. After the above-described steps are performed, the first substrate can be fed into the deposition chamber 10 in order to perform a new deposition procedure, and the stable conditions in the deposition chamber 10 facilitate improving uniformity of the thin film deposited on the first substrate.

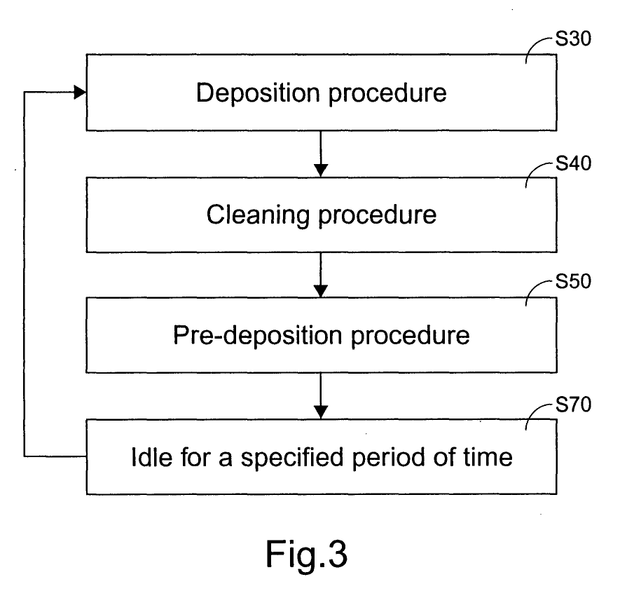

Alternatively, another method for improving uniformity of a film in PECVD system is shown in the flowchart of FIG. 3. The deposition procedure S30, the cleaning procedure S40 and the pre-deposition procedure S50, which are the same as those of FIG. 2, are sequentially carried out. Then, in Step S70, the deposition chamber 10 is kept idle for a specified period of time so as to stabilize a condition such as temperature distribution of the deposition chamber 10. Preferably, the specified period of time is ranged from 1minute to 20 minutes. After the above-described steps are performed, the first substrate can be fed into the deposition chamber 10 in order to perform a new deposition procedure, and the stable condition in the deposition chamber 10 facilitates improving uniformity of a thin film deposited on the first substrate.

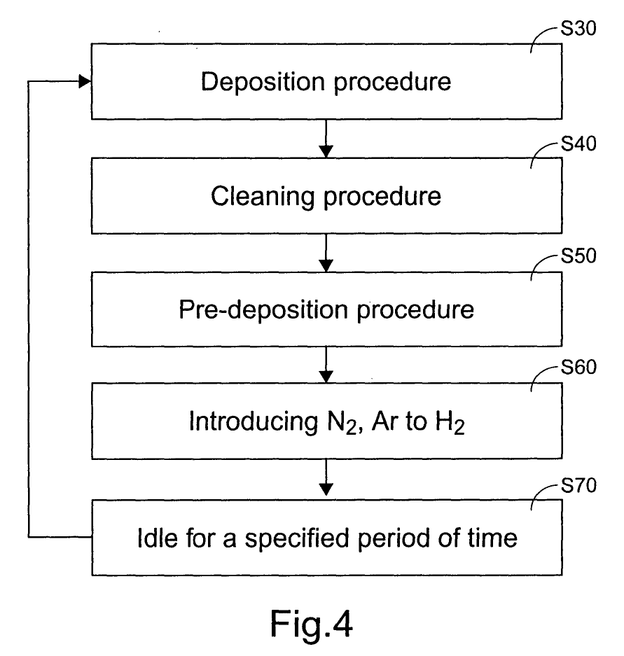

Alternatively, another method for improving uniformity of a film in PECVD system is shown in the flowchart of FIG. 4. The deposition procedure S30, the cleaning procedure S40 and the pre-deposition procedure S50, which are the same as those of FIG. 2, are sequentially carried out. Then, Step S60 is performed by introducing a specified gas into the deposition chamber 10, thereby diluting contaminants in the deposition chamber 10 and stabilizing a condition such as a temperature of the deposition chamber 10. Then, the deposition chamber 10 is kept idle for a specified period of time so as to stabilize a condition such as temperature distribution of the deposition chamber 10 (Step S70). In such way, the thin film deposited on the first substrate will have an improved uniformity. The sequences for performing Steps S60 and S70 can be exchanged so as to provide animproved uniformity of the first substrate.

While the invention has been described in terms of what is presently considered to be the most practical and preferred embodiments, it is to be understood that the invention needs not be limited to the disclosed embodiment. On the contrary, it is intended to cover various modifications and similar arrangements, including but not limited to, various sequencing of various stabilizing steps as described above, within the spirit and scope of the appended claims which are to be accorded with the broadest interpretation so as to encompass all such modifications and similar structures.

1. A method for improving uniformity of a film in a plasma enhanced chemical vapor deposition system in a deposition chamber, said method comprising, before a deposition procedure, steps of:
performing a cleaning procedure to remove particles adhered onto an internal wall of said deposition chamber;
performing a pre-deposition procedure to isolate contaminants generated during said cleaning procedure; and
introducing a specified gas into said deposition chamber so as to stabilize a condition inside said deposition chamber.

2. The method according to claim 1 wherein said contaminants include fluoride.

3. The method according to claim 1 wherein said specified gas comprises at least a nitrogen gas.

4. The method according to claim 1 wherein said specified gas comprises at least an argon gas.

5. The method according to claim 1 wherein said specified gas comprises at least a hydrogen gas.

6. The method according to claim 1 wherein said condition to be stabilized is the temperature distribution condition in said deposition chamber.

7. The method according to claim 1 wherein said condition to be stabilized is the contaminant concentration in said deposition chamber.

8. The method according to claim 1 wherein said cleaning procedure is performed by introducing a nitrogen fluoride gas into said deposition chamber.

9. The method according to claim 1 wherein said pre-deposition procedure is performed by introducing a reaction gas without placing any substrate into said deposition chamber.

10. The method according to claim 1 further comprising a step of idling said deposition chamber for a specified period of time for stabilizing temperature distribution in said deposition chamber.

11. A method for improving uniformity of a film in a plasma enhanced chemical vapor deposition system in a deposition chamber, said method comprising, before a deposition procedure, steps of:
performing a cleaning procedure to remove particles adhered onto an internal wall of said deposition chamber;
performing a pre-deposition procedure to isolate contaminants generated during said cleaning procedure; and
idling said deposition chamber for a specified period of time so as to stabilize a condition inside said deposition chamber.

12. The method according to claim 11 wherein said condition to be stabilized is the temperature distribution condition of said deposition chamber.

13. The method according to claim 11 further comprising a step of introducing a specified gas into said deposition chamber so as to dilute said contaminants inside said deposition chamber.

14. The method according to claim 11 wherein said cleaning procedure is performed by introducing a nitrogen fluoride gas into said deposition chamber.

15. The method according to claim 11 wherein said pre-deposition procedure is performed by introducing a reaction gas without placing any substrate into said deposition chamber.

16. The method according to claim 11 wherein said specified period of time is ranged from 1 minute to 20 minutes.

17. A method for improving uniformity of a film in a plasma enhanced chemical vapor deposition system in a deposition chamber, said method comprising, before a deposition procedure, steps of:
performing a cleaning procedure to remove particles adhered onto an internal wall of said deposition chamber;
performing a pre-deposition procedure to isolate contaminants generated during said cleaning procedure; and
diluting contaminants in said deposition chamber so as to stabilize a condition inside said deposition chamber.

18. The method according to claim 17 wherein said contaminants are diluted with an introduced gas.

19. The method according to claim 17 wherein said introduced gas includes at least a gas selected from a group consisting of nitrogen, argon, hydrogen and a combination thereof.

20. The method according to claim 17 further comprising a step of idling said deposition chamber for a specified period of time for stabilizing a temperature distribution of said deposition chamber.

21. The method according to claim 20 wherein said specified period of time is ranged from 1 minute to 20 minutes.
